(19) United States
(12) Patent Application Publication
(10) Pub. No.: US 2024/0057601 A1
(43) Pub. Date: Feb. 22, 2024

(54) PESTICIDAL COMPOSITION

(71) Applicant: SUMITOMO CHEMICAL COMPANY, LIMITED, Chuo-ku (JP)

(72) Inventors: Saki MATSUSHITA, Takarazuka-shi (JP); Ai RUSU, Takarazuka-shi (JP)

(73) Assignee: SUMITOMO CHEMICAL COMPANY, LIMITED, Chuo-ku (JP)

(21) Appl. No.: 18/255,000

(22) PCT Filed: Nov. 30, 2021
(86) PCT No.: PCT/JP2021/043751

§ 371 Date: May 30, 2023

(30) Foreign Application Priority Data
Dec. 1, 2020 (JP) 2020-199853

(51) Int. Cl. A01N 43/54; A01P 13/00; A01N 37/40; A01N 25/04; A01N 25/30

(52) U.S. Cl. CPC A01N 43/54; A01P 13/00; A01N 37/40; A01N 25/04; A01N 25/30

(57) ABSTRACT

Provided is a pesticidal composition comprising a compound represented by the formula (I), a herbicidal active salt, an organic solvent having a water solubility at 25° C. of 10 mass % or less, a surfactant and water, wherein the surfactant comprises one or more nonionic surfactants selected from a group (A). Group (A): the group consisting of polyoxyethylene alkyl ethers having the number of added EO exceeding 6, polyoxyethylene aryl ethers having the number of added EO exceeding 20, polyoxyethylene sorbitan fatty acid esters having the number of added EO exceeding 4, polyoxyethylene polyoxypropylene block copolymers having the number of added EO exceeding 11, polyoxyethylene castor oils having the number of added EO exceeding 10, and polyoxyethylene fatty acid esters having the number of added EO exceeding 8.

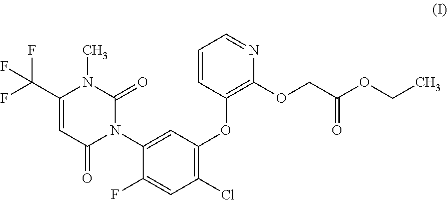 [SMILES: CCOC(=O)COc1ncccc1Oc1cc(-n2c(=O)cc(C(F)(F)F)n(C)c2=O)c(F)cc1Cl]

### TECHNICAL FIELD

The present invention relates to a pesticidal composition.

### BACKGROUND ART

Japanese Patent Laying-Open No. 09-124421 (Patent Literature 1) describes an emulsion formulation containing an isopropylamine salt of glyphosate, an alkylbenzene derivative, a polyoxyethylene castor oil, glycols and water.

A compound represented by the following formula (I), which is an active ingredient for herbicides, is known as a pesticidal active compound (see, e.g., U.S. Pat. No. 6,537,948 (Patent Literature 2)).

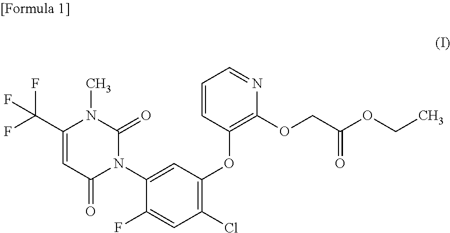 [SMILES: CCOC(=O)COc1ncccc1Oc1cc(-n2c(=O)cc(C(F)(F)F)n(C)c2=O)c(F)cc1Cl]

### CITATION LIST

### Patent Literature

PTL 1: Japanese Patent Laying-Open No. 09-124421
PTL 2: U.S. Pat. No. 6,537,948

### SUMMARY OF INVENTION

### Technical Problem

An object of the present invention is to provide a liquid pesticidal composition comprising a compound represented by the formula (I) and a herbicidal active salt, wherein the liquid pesticidal composition has favorable stability of an emulsion when stored.

### Solution to Problem

The present invention provides the following pesticidal composition.

[1] A pesticidal composition comprising a compound represented by the formula (I), a herbicidal active salt, an organic solvent having a water solubility at 25° C. of 10 mass % or less, a surfactant and water, wherein

the surfactant comprises one or more nonionic surfactants selected from a group (A):

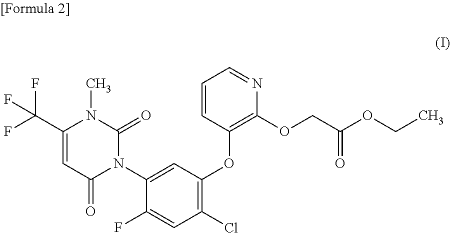 [SMILES: CCOC(=O)COc1ncccc1Oc1cc(-n2c(=O)cc(C(F)(F)F)n(C)c2=O)c(F)cc1Cl]

group (A): the group consisting of polyoxyethylene alkyl ethers having the number of added EO exceeding 6, polyoxyethylene aryl ethers having the number of added EO exceeding 20, polyoxyethylene sorbitan fatty acid esters having the number of added EO exceeding 4, polyoxyethylene polyoxypropylene block copolymers having the number of added EO exceeding 11, polyoxyethylene castor oils having the number of added EO exceeding 10, and polyoxyethylene fatty acid esters having the number of added EO exceeding 8.

[2] The pesticidal composition according to [1], wherein the herbicidal active salt comprises a herbicidal active carboxylate.

[3] The pesticidal composition according to [1], wherein the herbicidal active salt comprises one or more herbicidal active salts selected from the group consisting of a herbicidal active benzoate and a herbicidal active phenoxyacetate.

[4] The pesticidal composition according to [1], wherein the herbicidal active salt comprises one or more herbicidal active salts selected from the group consisting of a dicamba salt and a 2,4-D salt.

[5] The pesticidal composition according to [1], wherein the herbicidal active salt comprises a dicamba salt.

[6] The pesticidal composition according to [1], wherein the herbicidal active salt comprises dicamba diglycolamine.

[7] The pesticidal composition according to any of [1] to [6], wherein the surfactant is one or more nonionic surfactants selected from the group (A).

[8] The pesticidal composition according to any of [1] to [7], wherein the pesticidal composition contains an aqueous phase and particles of an oil phase dispersed in the aqueous phase, wherein the oil phase contains the organic solvent and the compound represented by the formula (I) dissolved or suspended in the organic solvent.

[9] The pesticidal composition according to any of [1] to [8], wherein the organic solvent comprises an aromatic hydrocarbon.

### Advantageous Effects of Invention

It is made possible to provide a liquid pesticidal composition comprising a compound represented by the formula (I) and a herbicidal active salt, wherein the liquid pesticidal composition has favorable stability of an emulsion when stored.

### DESCRIPTION OF EMBODIMENTS

A pesticidal composition according to the present invention (hereinafter, also simply called “pesticidal composition”) contains a compound represented by the formula (I) (hereinafter, also called “compound (I)”), a herbicidal active salt, an organic solvent having a water solubility at 25° C. of 10 mass % or less, a surfactant and water. The pesticidal composition is usually an oil-in-water emulsion containing an aqueous phase and particles of an oil phase dispersed in the aqueous phase. The oil phase contains the organic solvent having a water solubility at 25° C. of 10 mass % or less and the compound (I) dissolved or suspended in the organic solvent.

In the following, a detailed description will be given of ingredients that the pesticidal composition contains or may contain.

[1] Pesticidal Active Compound

The pesticidal composition contains a compound (1) as a first pesticidal active compound. In the pesticidal composition, the compound (I) is contained in the oil phase and dissolved or suspended in the organic solvent having a water solubility at 25° C. of 10 mass % or less, which constitutes the oil phase.

With the total amount of the pesticidal composition being taken as 100 mass %, the content of the compound (1) in the pesticidal composition is preferably 0.01 mass % or more and 25 mass % or less, more preferably 0.05 mass % or more and 20 mass % or less, further preferably 0.1 mass % or more and 15 mass % or less, yet further preferably 0.2 mass % or more and 10 mass % or less, in view of moderately elevating the content and improving the stability of an emulsion (property of being able to continuously maintain a stable emulsified state) when stored of the pesticidal composition.

The pesticidal composition contains one, two, or more herbicidal active salts as a second pesticidal active compound. Usually, the aqueous phase contains the herbicidal active salt(s). The herbicidal active salt is a herbicidal active compound in a salt form, and examples thereof include herbicidal active carboxylates, herbicidal active thiocarbonates, herbicidal active sulfonates, herbicidal active sulfinates, herbicidal active thiosulfonates or herbicidal active phosphites. The herbicidal active salt is preferably a herbicidal active carboxylate. A portion of the herbicidal active salt may be present in a neutral state in the pesticidal composition. For example, when the herbicidal active salt is carboxylates, the carboxylate group (—COO⁻ group) of the salt may be present in equilibrium with a carboxy group (—COOH group).

Examples of the herbicidal active salt include herbicidal active carboxylates, herbicidal active thiocarbonates, herbicidal active sulfonates, herbicidal active sulfinates, herbicidal active thiosulfonates and herbicidal active phosphites listed in The Pesticide Manual Fifteenth Edition (2009), British Crop Production Council (ISBN: 978-1-901396-18-8), and examples of the herbicidal active carboxylate include the following:
herbicidal active benzoates such as diflufenzopyr salt, naptalam salt, dicamba salt, and 2,3,6-trichlorobenzoic acid (2,3,6-TBA) salt;
herbicidal active pyrimidinyloxybenzoates such as bispyribac sodium;
herbicidal active pyrimidinylthiobenzoates such as pyrithiobac sodium;
herbicidal active picolinates such as aminopyralid salt, clopyralid salt, and picloram salt;
aromatic acid salts such as aminocyclopyrachlor salt and imazethapyr salts (e.g., imazethapyr ammonium);
herbicidal active phenoxyacetates such as (2,4-dichlorophenoxy)acetic acid (2,4-D) salt, MCPA (4-(4-chloro-o-tolyloxy)acetic acid) salt, and (2,4,5-trichlorophenoxy)acetic acid (2,4,5-T) salt;
herbicidal active phenoxybutyrates such as 4-(2,4-dichlorophenoxy)butyric acid (2,4-DB) salt and 4-(4-chloro-o-tolyloxy) butyric acid (MCPB) salt;
herbicidal active phenoxypropionates such as dichlorprop salt, dichlorprop-P salt, fenoprop salt, mecoprop salt, and mecoprop-P salt; and
herbicidal active salts classified into carboxylic acid-containing organophosphorus herbicides such as glufosinate ammonium, glufosinate-P ammonium, and glyphosate salts (e.g., glyphosate potassium, glyphosate dimethylamine, glyphosate monoethanolamine, and glyphosate isopropylammonium).

The herbicidal active salt is preferably a herbicidal active carboxylate, more preferably one or more herbicidal active salts selected from the group consisting of herbicidal active benzoates and herbicidal active phenoxyacetates, further preferably one or more herbicidal active salts selected from the group consisting of dicamba salts and 2,4-D salts, yet further preferably a dicamba salt.

Examples of the dicamba salt include dicamba diglycolamine, dicamba tetrabutylamine, dicamba tetrabutylphosphonium and dicamba N,N-bis(3-aminopropyl)methylamine, with dicamba diglycolamine being preferable. The pesticidal composition can contain one, two, or more dicamba salts.

Examples of the 2,4-D salt include 2,4-D ammonium, 2,4-D diethylammonium, 2,4-D dimethylammonium, 2,4-D diolamine, 2,4-D dodecylammonium, 2,4-D heptylammonium, 2,4-D isopropylammonium, 2,4-D lithium, 2,4-D sodium, 2,4-D tetradecylammonium, 2,4-D triethylammonium, 2,4-D tris(2-hydroxypropyl)ammonium, 2,4-D trolamine, and 2,4-D choline. The pesticidal composition can contain one, two, or more 2,4-D salts.

With the total amount of the pesticidal composition being taken as 100 mass %, the content of the herbicidal active salt in the pesticidal composition is preferably 0.1 mass % or more and 80 mass % or less, more preferably 0.5 mass % or more and 70 mass % or less, further preferably 1 mass % or more and 60 mass % or less, yet further preferably 2 mass % or more and 50 mass % or less. The amount of the herbicidal active salt herein refers to an amount as the acid equivalent of the herbicidal active salt unless otherwise specified.

The pesticidal composition may contain a pesticidal active compound other than the compound (I) and the herbicidal active salt. Examples of the pesticidal active compound other than the compound (I) and the herbicidal active salt include, but are not particularly limited to, insecticidal active ingredients, fungicidal active ingredients and herbicidal active ingredients. The pesticidal composition can contain one or more pesticidal active ingredients selected from the group consisting of insecticidal active ingredients, fungicidal active ingredients and herbicidal active ingredients as the pesticidal active compound other than the compound (1) and the herbicidal active salt. Each of the insecticidal active ingredient, the fungicidal active ingredient and the herbicidal active ingredient may comprise one, two, or more ingredients.

With the total amount of the pesticidal active compound contained in the pesticidal composition being taken as 100 mass %, the total content of the compound (I) and the herbicidal active salt in all the pesticidal active compounds contained in the pesticidal composition is, for example, 50 mass % or more and 100 mass % or less. The content is preferably 60 mass % or more and 100 mass % or less, more preferably 80 mass % or more and 100 mass % or less, further preferably 90 mass % or more and 100 mass % or less, particularly preferably 95 mass % or more and 100 mass % or less.

The content of the herbicidal active salt relative to the content of the compound (I) is usually 1 time by mass or more and 100 times by mass or less, preferably 2 times by mass or more and 80 times by mass or less, more preferably 5 times by mass or more and 70 times by mass or less, further preferably 10 times by mass or more and 60 times by mass or less.

[2] Organic Solvent

The pesticidal composition contains an organic solvent having a water solubility at 25° C. of 10 mass % or less. Hereinafter, this organic solvent is also called “organic solvent A”. The organic solvent A may dissolve the compound (I). The pesticidal composition may contain one, two, or more organic solvents A.

The water solubility at 25° C. of the organic solvent A may be, for example, 8 mass % or less, may be 5 mass % or less, may be 3 mass % or less, and may be 1 mass % or less. It is preferable that the pesticidal composition contain the organic solvent A having water solubility within the range because the storage stability of an emulsion and emulsion stability when diluted of the pesticidal composition are improved. The water solubility at 25° C. of the organic solvent A is usually 0 mass % or more and may be 10⁻⁵ mass % or more.

The water solubility at 25° C. herein refers to the solubility in water at a temperature of 25° C. and pH 7. For example, a water solubility at 25° C. of 10 mass % means that the solubility in 1 g of water at a temperature of 25° C. and pH 7 is 1×10⁻¹ g.

As the water solubility of the organic solvent, a value found in the database (Solubility Database) of International Union of Pure and Applied Chemistry (IUPAC) or National Institute of Standards and Technology (NIST) may be used. When a corresponding value is not found in the database, the water solubility of the organic solvent may be measured by determining the saturation solubility in water at a temperature of 25° C. and pH 7 by high-performance liquid chromatography.

Examples of the organic solvent A contained in the pesticidal composition include:
alcohols such as butanol, amyl alcohol, hexanol, heptanol, octanol, 2-ethylhexanol, cyclohexanol and benzyl alcohol;
esters such as acetic acid esters (e.g., ethyl acetate, butyl acetate, isoamyl acetate, isobornyl acetate, hexyl acetate, heptyl acetate, octyl acetate, and benzyl acetate), carbonic acid esters (e.g., diethyl carbonate and dibutyl carbonate), fatty acid esters (e.g., isopropyl myristate, methyl octanoate, methyl oleate, methyl laurate, dimethyl adipate, dibutyl adipate, didecyl adipate, tri-n-butyl citrate, di-n-butyl phthalate, methyl caprylate, methyl laurate, methyl myristate, methyl salicylate, methyl palmitate, methyl oleate, and ethyl palmitate), phthalic acid esters (e.g., dimethyl phthalate and diethyl phthalate), benzoic acid esters (e.g., methyl benzoate and ethyl benzoate), succinic acid esters (e.g., dioctyl succinate), and acetoacetic acid esters (e.g., tert-butyl acetoacetate and allyl acetoacetate);
ethers such as propylene glycol phenyl ether;
ketones such as cyclohexanone, 2-heptanone, isophorone, mesityl oxide, methyl isoamyl ketone, methyl isobutyl ketone, methylcyclohexanone, and acetophenone;
amides such as fatty acid dimethylamides (e.g., N,N-dimethyldecanamide, N,N-dimethyldodecanamide, N,N-dimethyltetradecanamide, and N,N-dimethyloctadecanamide), and alkylpyrrolidones (e.g., N-octyl-pyrrolidone, N-dodecyl-pyrrolidone, and N-decyl-pyrrolidone);
lactones such as γ-octanolactone and δ-octanolactone;
amines such as n-octylamine, oleylamine, and laurylamine;
aliphatic hydrocarbons such as decane, tridecane, tetradecane, hexadecane, octadecane, normal paraffin, isoparaffin, cycloparaffin, 1-undecene and 1-heneicosene;
aromatic hydrocarbons such as toluene, xylene, alkylbenzenes such as ethylbenzene, octadecylbenzene, dialkylbenzene and trialkylbenzene, alkylnaphthalenes such as methylnaphthalene, dimethylnaphthalene, dodecylnaphthalene and tridecylnaphthalene, and phenylxylylethane and 1-phenyl-1-ethylphenylethane, and a mixture of these;
fatty acids such as oleic acid, capric acid, and enanthic acid;
animal- or vegetable-derived oils such as coconut oil, olive oil, soybean oil, rape oil, castor oil, linseed oil, cottonseed oil, palm oil, avocado oil, shark liver oil, sardine oil, and saury oil;
mineral oils such as naphtha, petroleum ether, kerosene, diesel oil, paraffin, olefin, and machine oil; and
silicone oil.

As the organic solvent A, a commercially available solvent may be used. Examples of the commercially available product include, in trade names, Agnique AMD810 (mixture of N,N-dimethyloctanamide and N,N-dimethyldecanamide, manufactured by BASF), Agnique AMD10 (N,N-dimethyldecanamide, manufactured by BASF), Agnique AMD12 (N,N-dimethyldodecanamide, manufactured by BASF), Rhodiasolv ADMA810 (mixture of N,N-dimethyloctanamide and N,N-dimethyldecanamide, manufactured by Solvay Nicca), Rhodiasolv ADMA-10 (N,N-dimethyldecanamide, manufactured by Solvay Nicca), Hallcomid M-8-10 (mixture of N,N-dimethyloctanamide and N,N-dimethyldecanamide, manufactured by Stepan), Hallcomid M-10 (N,N-dimethyldecanamide, manufactured by Stepan), Hallcomid M-12 (N,N-dimethyldodecanamide, manufactured by Stepan), Hallcomid M-18 (N,N-dimethyloctadecanamide, manufactured by Stepan), Hallcomid 1025 (N,N-dimethyl-9-deceneamide, manufactured by Stepan), Genagen 4166 (fatty acid dimethylamide, manufactured by Clariant), Genagen 4296 (fatty acid dimethylamide, manufactured by Clariant), Rhodiasolv Iris (mixture of dimethyl 2-methylglutarate, dimethyl 2-ethylsuccinate, and dimethyl adipate, manufactured by Solvay), PURASOLV EHL (2-ethylhexyl-L-lactate, manufactured by Corbion purac), AGSOLEX 8 (N-octyl-pyrrolidone, manufactured by Ashland), AGSOLEX 12 (N-dodecyl-pyrrolidone, manufactured by Ashland), Stepan C-25 (methyl caprylate, manufactured by Stepan), Stepan C-42 (mixture of methyl laurate and methyl myristate, manufactured by Stepan), Stepan C-65 (mixture of methyl palmitate and methyl oleate, manufactured by Stepan), Dowanol PPh (propylene glycol phenyl ether, manufactured by Dow Chemical), Nisseki Hisol SAS-296 (mixture of 1-phenyl-1-xylylethane and 1-phenyl-1-ethylphenylethane, manufactured by JX Nippon Oil & Energy), SOLVESSO 100 (containing C9-C10 dialkyl- and trialkylbenzene as its main aromatic hydrocarbon, manufactured by ExxonMobil Chemical), SOLVESSO 150 (containing C10-C11 alkyl benzene as its main aromatic hydrocarbon, manufactured by ExxonMobil Chemical), SOLVESSO 150ND (containing C10-C11 alkyl benzene as its main aromatic hydrocarbon, manufactured by ExxonMobil Chemical), SOLVESSO 200 (containing C10-C13 alkyl naphthalene as its main aromatic hydrocarbon, manufactured by ExxonMobil Chemical), and SOLVESSO 200ND (containing C10-C13 alkyl naphthalene as its main aromatic hydrocarbon, manufactured by ExxonMobil Chemical).

In view of the solubility of the compound (I) and the storage stability of an emulsion and emulsion stability when diluted of the pesticidal composition, the organic solvent A preferably comprises one or more selected from the group consisting of aromatic hydrocarbons, aliphatic hydrocarbons, ketones, esters, ethers, amides, amines, and alcohols, and more preferably comprises an aromatic hydrocarbon. The aromatic hydrocarbon preferably comprises one or more selected from the group consisting of alkylbenzenes (e.g., toluene, xylene, ethylbenzene, octadecylbenzene, dialkylbenzene and trialkylbenzene), alkylnaphthalenes (e.g., methylnaphthalene, dimethylnaphthalene, dodecylnaphthalene and tridecylnaphthalene), and phenylxylylethane and 1-phenyl-1-ethylphenylethane, more preferably alkylbenzenes and alkylnaphthalenes, and further preferably comprises one or more selected from the group consisting of C9-C12 alkylbenzenes and C10-C15 alkylnaphthalenes. The organic solvent A may consist of an aromatic hydrocarbon.

With the total amount of the pesticidal composition being taken as 100 mass %, the content of the organic solvent A in the pesticidal composition is preferably 0.1 mass % or more and 45 mass % or less, more preferably 0.5 mass % or more and 40 mass % or less, further preferably 1 mass % or more and 35 mass % or less, yet further preferably 3 mass % or more and 30 mass % or less. It is preferable that the pesticidal composition contain the organic solvent A at a content within the range in view of moderately elevating the content of the compound (I) and improving the storage stability of an emulsion, emulsion stability when diluted and miscibility with a tank-mix partner of the pesticidal composition. The tank-mix partner is, for example, an adjuvant mentioned later, and can be mixed with the pesticidal composition by a method mentioned later.

The content of the organic solvent A relative to the content of the compound (I) is usually 2 times by mass or more and 35 times by mass or less, preferably 2.5 times by mass or more and 30 times by mass or less, more preferably 3 times by mass or more and 25 times by mass or less, further preferably 4 times by mass or more and 20 times by mass or less, particularly preferably 5 times by mass or more and 15 times by mass or less. In view of moderately elevating the content of the compound (I) and improving the storage stability of an emulsion, emulsion stability when diluted and miscibility with a tank-mix partner of the pesticidal composition, it is preferable that the ratio (mass ratio) of the content of the organic solvent A to the content of the compound (I) be adjusted to within the range.

When the pesticidal composition contains two or more organic solvents A, the content of the organic solvent A mentioned above is the total content of the two or more organic solvents A. The same holds true for other ingredients that the pesticidal composition contains or may contain, and the content of each ingredient is the total content of two or more ingredients, if contained, unless otherwise specified.

The pesticidal composition can contain an organic solvent other than the organic solvent A. However, for improving the storage stability of an emulsion of the pesticidal composition, it is preferable that the organic solvent contained in the pesticidal composition consist of the organic solvent A.

[3] Surfactant

The pesticidal composition contains a surfactant, and the surfactant comprises one or more nonionic surfactants selected from a group (A) given below. Containing the one or more nonionic surfactants selected from the group (A) contributes to improving the storage stability of an emulsion of the pesticidal composition.

Group (A): the group consisting of polyoxyethylene alkyl ethers having the number of added EO exceeding 6, polyoxyethylene aryl ethers having the number of added EO exceeding 20, polyoxyethylene sorbitan fatty acid esters having the number of added EO exceeding 4, polyoxyethylene polyoxypropylene block copolymers having the number of added EO exceeding 11, polyoxyethylene castor oils having the number of added EO exceeding 10, and polyoxyethylene fatty acid esters having the number of added EO exceeding 8.

The number of carbon atoms in the alkyl chain of the polyoxyethylene alkyl ether is usually 2 to 30, preferably 5 to 25, more preferably 10 to 20. Also, the alkyl chain may be branched. Examples of the polyoxyethylene alkyl ether include polyoxyethylene tridecyl ether, polyoxyethylene isooctyl ether, polyoxyethylene lauryl ether, polyoxyethylene hexadecyl ether, polyoxyethylene stearyl ether, polyoxyethylene oleyl ether, polyoxyethylene isotridecyl ether, and polyoxyethylene cetyl ether.

Examples of the polyoxyethylene aryl ether include polyoxyethylene monostyryl ether, polyoxyethylene distyryl ether, polyoxyethylene tristyryl phenyl ether, and polyoxyethylene tri-secondary butyl phenyl ether, with polyoxyethylene tristyryl phenyl ether being preferable.

The number of carbon atoms in the fatty acid of the polyoxyethylene sorbitan fatty acid ester is usually 2 to 30, preferably 5 to 25, more preferably 10 to 20. Also, the fatty acid may be a saturated fatty acid or may be an unsaturated fatty acid. Examples of the polyoxyethylene sorbitan fatty acid ester include polyoxyethylene sorbitan palmitic acid ester, polyoxyethylene sorbitan stearic acid ester, polyoxyethylene sorbitan lauric acid ester, and polyoxyethylene sorbitan oleic acid ester.

The number of carbon atoms in the fatty acid of the polyoxyethylene fatty acid ester is usually 2 to 30, preferably 5 to 25, more preferably 10 to 20. Also, the fatty acid may be a saturated fatty acid or may be an unsaturated fatty acid. Examples of the polyoxyethylene fatty acid ester include polyoxyethylene palmitic acid ester, polyoxyethylene stearic acid ester, polyoxyethylene lauric acid ester, and polyoxyethylene oleic acid ester, with polyoxyethylene stearic acid ester being preferable.

In view of the storage stability of an emulsion of the pesticidal composition, the number of added EO of the polyoxyethylene alkyl ether is preferably 12 or more, more preferably 17 or more. For this purpose, the number of added EO of the polyoxyethylene aryl ether is preferably 25 or more, more preferably 29 or more, further preferably 54 or more. For this purpose, the number of added EO of the polyoxyethylene sorbitan fatty acid ester is preferably 6 or more, more preferably 10 or more, further preferably 20 or more. For this purpose, the number of added EO of the polyoxyethylene polyoxypropylene block copolymer is preferably 15 or more, more preferably 20 or more, further preferably 30 or more, yet further preferably 40 or more, particularly preferably 50 or more, furthermore preferably 54 or more. For this purpose, the number of added EO of the polyoxyethylene castor oil is preferably 12 or more, more preferably 16 or more. For this purpose, the number of added EO of the polyoxyethylene fatty acid ester is preferably 10 or more, more preferably 15 or more, further preferably 20 or more.

The pesticidal composition may contain a surfactant other than the nonionic surfactant selected from the group (A). Examples of the surfactant other than the nonionic surfactant selected from the group (A) include anionic surfactants, cationic surfactants, amphoteric surfactants, and nonionic surfactants other than the nonionic surfactant selected from the group (A).

With the total amount of the surfactant contained in the pesticidal composition being taken as 100 mass %, the content of the nonionic surfactant selected from the group (A) in all the surfactants contained in the pesticidal composition is, for example, 50 mass % or more and 100 mass % or less. The content is preferably 60 mass % or more and 100 mass % or less, more preferably 70 mass % or more and 100 mass % or less, further preferably 80 mass % or more and 100 mass % or less. For improving the storage stability of an emulsion of the pesticidal composition, it is preferable that the surfactant contained in the pesticidal composition consist of the nonionic surfactant selected from the group (A).

With the total amount of the pesticidal composition being taken as 100 mass %, the content of the surfactant in the pesticidal composition is preferably 0.5 mass % or more and 30 mass % or less, more preferably 0.7 mass % or more and 25 mass % or less, further preferably 0.8 mass % or more and 20 mass % or less, yet further preferably 1 mass % or more and 15 mass % or less, particularly preferably 1.5 mass % or more and 10 mass % or less, in view of improving the storage stability of an emulsion, emulsion stability when diluted and miscibility with a tank-mix partner of the pesticidal composition.

The content of the surfactant relative to the content of the pesticidal active compound is preferably 0.05 times by mass or more and 30 times by mass or less, more preferably 0.07 times by mass or more and 25 times by mass or less, further preferably 0.1 times by mass or more and 20 times by mass or less, particularly preferably 0.1 times by mass or more and 15 times by mass or less.

The content of the surfactant relative to that of the organic solvent is preferably 0.01 times by mass or more and 10 times by mass or less, more preferably 0.02 times by mass or more and 9 times by mass or less, further preferably 0.04 times by mass or more and 8 times by mass or less, particularly preferably 0.05 times by mass or more and 6 times by mass or less.

[4] Water

The pesticidal composition contains water. Examples of the water include ion-exchange water, tap water and groundwater. The water constitutes the aqueous phase of the pesticidal composition.

With the total amount of the pesticidal composition being taken as 100 mass %, the content of the water in the pesticidal composition is preferably 30 mass % or more and 95 mass % or less, more preferably 35 mass % or more and 93 mass % or less, further preferably 40 mass % or more and 90 mass % or less, yet further preferably 45 mass % or more and 87 mass % or less. For improving the storage stability of an emulsion of the pesticidal composition, it is preferable that the pesticidal composition contain the water at a content within the range.

[5] Other Ingredients

The pesticidal composition may contain a formulation aid. Examples of other formulation aids include thickeners, antifoaming agents, antifreezing agents, and antiseptics.

Examples of the thickener include polysaccharides such as xanthan gum, guar gum, welan gum, diutan gum, and cellulose nanofibers, clay, and silicates. With the total amount of the pesticidal composition being taken as 100 mass %, the content of the thickener in the pesticidal composition is usually 0.00 mass % or more and may be 0.05 mass % or more, and is usually 5 mass % or less and may be 3 mass % or less.

Examples of the antifoaming agent include silicone-based antifoaming agents. With the total amount of the pesticidal composition being taken as 100 mass %, the content of the antifoaming agent in the pesticidal composition is usually 0.01 mass % or more and may be 0.05 mass % or more, and is usually 1 mass % or less and may be 0.5 mass % or less.

Examples of the antifreezing agent include ethylene glycol, propylene glycol, urea, and glycerin. With the total amount of the pesticidal composition being taken as 100 mass %, the content of the antifreezing agent in the pesticidal composition is usually 1 mass % or more and may be 2 mass % or more, and is usually 10 mass % or less and may be 8 mass % or less.

Examples of the antiseptic include isothiazolinone-based antiseptics. With the total amount of the pesticidal composition being taken as 100 mass %, the content of the antiseptic in the pesticidal composition is usually 0.05 mass % or more and may be 0.1 mass % or more, and is usually 0.5 mass % or less and may be 0.3 mass % or less.

The compound (I) which is a pesticidal active compound, the organic solvent and an optional surfactant are mixed to prepare an oil phase. The herbicidal active salt, a formulation aid, water and an optional surfactant are mixed to prepare an aqueous phase. The aqueous phase may or may not contain the herbicidal active salt. The surfactant may be added to the organic solvent, may be added to the water, or may be added to both. The oil phase is added to the aqueous phase and emulsified using a stirrer such as a homogenizer, and the resultant is mixed with an optional formulation aid such as a thickener, an antiseptic, and an antifoaming agent to obtain a pesticidal composition.

The surfactant may be added at a plurality of timings. For example, the process of obtaining an emulsified liquid in the presence of a portion of the surfactant may be carried out, followed by the addition of another portion of the surfactant.

The volume median diameter of the oil phase particles contained in the pesticidal composition may be, for example, 0.01 μm or larger and 20 μm or smaller. The volume median diameter of the oil phase particles is, for example, 0.05 μm or larger and 15 μm or smaller, 0.1 μm or larger and 10 μm or smaller, 0.2 μm or larger and 8 μm or smaller or 0.3 μm or larger and 7 μm or smaller. The volume median diameter herein refers to a particle diameter at which a cumulative frequency becomes 50% in a particle size distribution. The volume median diameter of the oil phase particles is measured using a particle diameter measurement apparatus based on a laser diffraction method or a dynamic light scattering method as measurement principles. 0.4 μm or larger is a value measured by the laser diffraction method, and less than 0.4 μm is a value measured by the dynamic light scattering method. As a commercially available particle diameter measurement apparatus based on a laser diffraction method as measurement principles, Mastersizer 3000 (manufactured by Malvern Panalytical) can be used, and as a particle diameter measurement apparatus based on a dynamic light scattering method as measurement principles, Zetasizer nano zsp (manufactured by Malvern Panalytical) can be used.

The storage stability of an emulsion of the pesticidal composition may be confirmed from the presence or absence of oil separation during high-temperature (e.g., 54° C.) storage. According to the present invention, it is possible to suppress oil separation after high-temperature storage.

[6] Use of Pesticidal Composition

The pesticidal composition can be suitably used as a liquid pesticidal formulation called emulsion oil in water (EW) in the pesticidal field.

The pesticidal composition can be used in crop lands such as dry fields, orchard fields, pastures, lawn fields, and forestry fields; and non-crop lands such as levee slopes, riverbeds, shoulders and slopes of the roads, railroads, parks and green spaces, playgrounds, automobile parks, airports, and industrial plant sites such as factories and storage facilities as well as idle fields and urban deserts, thereby controlling weeds.

Users prepare an emulsified liquid by usually mixing the pesticidal composition with water, and applies the emulsified liquid from a knapsack sprayer, a spray tank, a spray plane, or an irrigation system. The amount of spray differs depending on climate conditions, the timing of treatment, soil conditions, target crops, target weeds, etc. and is usually 10 L or more and 2000 L or less, preferably 50 L or more and 400 L or less, per hectare. Also, the emulsified liquid is prepared by mixing the pesticidal composition with water in usually from 2 to 10000 times, preferably from 10 to 8000 times, more preferably from 15 to 6000 times the volume of an emulsion oil in water.

In applying the emulsified liquid, it may be mixed with an adjuvant. Although the type of the adjuvant is not particularly limited, it is preferable to mix an oil-based adjuvant (methylated seed oil in which a mineral oil such as a paraffinic hydrocarbon, a naphthenic hydrocarbon, or an aromatic hydrocarbon, or a vegetable oil (soybean oil or rapeseed oil) is esterified) such as Agri-Dex or MSO at 0.25%, 0.5%, 1%, 2%, 3%, 4%, 5% or 6% (volume/volume) into the spray liquid, or a nonionic adjuvant (polyoxyalkylene alkyl ether, polyoxyalkylene fatty acid ester, alkylaryl alkoxylate, or alkylaryl polyoxyalkylene glycol) such as Induce at 0.05%, 0.1%, 0.25%, or 0.5% (volume/volume) into the spray liquid. Other examples thereof include anionic series (substituted sulfonates) such as Gramin S, cationic series (polyoxyethyleneamine) such as Genamin T 200BM, and organic silicone series such as Silwet L77. Furthermore, a drift control agent such as Intact (polyethylene glycol) or a volatilization-reducing agent such as Vapex, a VaporGrip Xtra Agent (mixture of potassium hydroxide and acetic acid) may be mixed. The pH or hardness of the spray liquid is not particularly limited.

### EXAMPLES

In the following, the present invention will be described in further detail with reference to Examples and Comparative Examples, etc. The scope of the present invention is not limited to these Examples.

The products used in the preparation of pesticidal compositions will be given below.

[1] Dicamba DGA: Dicamba diglycolamine (an aqueous solution of 59 mass % of the salt (40 mass % as an acid) was used for the preparation of pesticidal compositions, whereas the amounts specified in Tables 1 and 2 are the amounts of the dicamba diglycolamine itself.)

[2] Solvesso 200ND: Containing C10-C13 alkylnaphthalene as its main aromatic hydrocarbon, manufactured by ExxonMobil Chemical

[3] Genapol T-500P: C16/18-aliphatic alcohol polyglycol ether, the number of added EO: 50, manufactured by Clariant

[4] Brij CS17: Polyoxyethylene linear alkyl ether, the number of added EO: 17, manufactured by Croda

[5] Brij 020: Polyoxyethylene oleyl ether, the number of added EO: 20, manufactured by Croda

[6] MAKON TD-6: Polyoxyethylene isotridecyl ether, the number of added EO: 6, manufactured by Stepan

[7] Emulsogen EL540: Polyoxyethylene castor oil, the number of added EO: 54, manufactured by Clariant

[8] Toximul 8242: Polyoxyethylene castor oil, the number of added EO: 40, manufactured by Stepan

[9] Toximul 8241: Polyoxyethylene castor oil, the number of added EO: 30, manufactured by Stepan

[10] Toximul 8243: Polyoxyethylene castor oil, the number of added EO: 20, manufactured by Stepan

[11] Toximul 8244: Polyoxyethylene castor oil, the number of added EO: 16, manufactured by Stepan

[12] Etocas 10: Polyoxyethylene castor oil, the number of added EO: 10, manufactured by Croda

[13] Emulsogen TS540: Polyoxyethylene tristyryl phenyl ether, the number of added EO: 54, manufactured by Clariant

[14] Emulsogen TS200: Polyoxyethylene tristyryl phenyl ether, the number of added EO: 20, manufactured by Clariant

[15] Myrj S100: Polyoxyethylene stearic acid ester, the number of added EO: 100, manufactured by Croda

[16] Myrj S40: Polyoxyethylene stearic acid ester, the number of added EO: 40, manufactured by Croda

[17] Myrj S20: Polyoxyethylene stearic acid ester, the number of added EO: 20, manufactured by Croda

[18] Myrj S8: Polyoxyethylene stearic acid ester, the number of added EO: 8, manufactured by Croda

[19] Tween 60: Polyoxyethylene sorbitan monostearate, the number of added EO: 20, manufactured by Croda

[20] Tween 80: Polyoxyethylene sorbitan monooleate, the number of added EO: 20, manufactured by Croda

[21] Tween 21: Polyoxyethylene sorbitan monolaurate, the number of added EO: 4, manufactured by Croda

[22] Stepflow 26F: Polyoxyethylene polyoxypropylene block copolymer, the number of added EO: 54, manufactured by Stepan

[23] Genapol PF20: Polyoxyethylene polyoxypropylene block copolymer, the number of added EO: 11, manufactured by Clariant

[24] Keltrol CG-LAX-T: xanthan gum, manufactured by CP KELCO

[25] Proxel GXL: 1,2-Benzisothiazolin-3-one, manufactured by Lonza

[26] Propylene glycol: manufactured by ADEKA

### Production Examples 1, 5, 11, and 13

To an aqueous solution containing 2.500 parts by mass of the surfactant specified in Table 1 or 2 dissolved in 30.000 parts by mass of water, a solution containing 0.536 parts by mass of the compound (I) active substance (purity: 98 mass %) dissolved in 5.250 parts by mass of Solvesso 200ND is added, and emulsified using Polytron homogenizer (manufactured by KINEMATICA) to obtain an emulsified liquid. To a mixed thickening agent of 0.110 parts by mass of Keltrol CG-LAX-T, 0.200 parts by mass of Proxel GXL, 5.000 parts by mass of Propylene glycol, and 5.690 parts by mass of water, the emulsified liquid, 13.964 parts by mass of water, and 36.750 parts by mass of an aqueous Dicamba DGA solution (acid equivalent concentration: 40 mass %) are added, and stirred to obtain a pesticidal composition. The pesticidal compositions obtained in Production Examples 1, 5, 11, and 13 are designated as pesticidal compositions 1, 5, 11, and 13, respectively.

The units of the values of each ingredient specified in Tables 1 and 2 are mass % with the total amount of the pesticidal composition being taken as 100 mass %.

### Production Examples 6, 7, and 20

0.536 parts by mass of the compound (I) active substance (purity: 98 mass %) and 2.500 parts by mass of the surfactant specified in Table 1 or 2 are dissolved in 5.250 parts by mass of Solvesso 200ND, and emulsified in 12.429 parts by mass of an aqueous Dicamba DGA solution (acid equivalent concentration: 40 mass %) using Polytron homogenizer (manufactured by KINEMATICA) to obtain an emulsified liquid. To a mixed thickening agent of 0.110 parts by mass of Keltrol CG-LAX-T, 0.200 parts by mass of Proxel GXL, 5.000 parts by mass of Propylene glycol, and 5.690 parts by mass of water, the emulsified liquid, 43.964 parts by mass of water, and 24.321 parts by mass of an aqueous Dicamba DGA solution (acid equivalent concentration: 40 mass %) are added, and stirred to obtain a pesticidal composition. The pesticidal compositions obtained in Production Examples 6, 7, and 20 are designated as pesticidal compositions 6, 7, and 20, respectively.

### Production Examples 3, 17, and 18

To an aqueous solution containing 2.500 parts by mass of the surfactant specified in Table 1 or 2 dissolved in 8.679 parts by mass of an aqueous Dicamba DGA solution (acid equivalent concentration: 40 mass %), a solution containing 0.536 parts by mass of the compound (I) active substance (purity: 98 mass %) dissolved in 5.250 parts by mass of Solvesso 200ND was added, and emulsified using Polytron homogenizer (manufactured by KINEMATICA) to obtain an emulsified liquid. To a mixed thickening agent of 0.110 parts by mass of Keltrol CG-LAX-T, 0.200 parts by mass of Proxel GXL, 5.000 parts by mass of Propylene glycol, and 5.690 parts by mass of water, the emulsified liquid, 43.964 parts by mass of water, and 28.071 parts by mass of an aqueous Dicamba DGA solution (acid equivalent concentration: 40 mass %) were added, and stirred to obtain a pesticidal composition. The pesticidal compositions obtained in Production Examples 3, 17, and 18 are designated as pesticidal compositions 3, 17, and 18, respectively.

### Production Example 14

To an aqueous solution containing 2.500 parts by mass of the surfactant specified in Table 2 dissolved in 22.655 parts by mass of an aqueous Dicamba DGA solution (acid equivalent concentration: 40 mass %), a solution containing 0.536 parts by mass of the compound (I) active substance (purity: 98 mass %) dissolved in 5.250 parts by mass of Solvesso 200ND was added, and emulsified using Polytron homogenizer (manufactured by KINEMATICA) to obtain an emulsified liquid. To a mixed thickening agent of 0.110 parts by mass of Keltrol CG-LAX-T, 0.200 parts by mass of Proxel GXL, 5.000 parts by mass of Propylene glycol, and 5.690 parts by mass of water, the emulsified liquid, 43.964 parts by mass of water, and 14.095 parts by mass of an aqueous Dicamba DGA solution (acid equivalent concentration: 40 mass %) were added, and stirred to obtain a pesticidal composition. The pesticidal composition obtained in Production Example 14 is designated as a pesticidal composition 14.

### Production Examples 2, 8, 9, and 15

0.536 parts by mass of the compound (I) active substance (purity: 98 mass %) and 2.500 parts by mass of the surfactant specified in Table 1 or 2 were dissolved in 5.250 parts by mass of Solvesso 200ND, and emulsified in 12.429 parts by mass of an aqueous Dicamba DGA solution (acid equivalent concentration: 40 mass %) using Polytron homogenizer (manufactured by KINEMATICA) to obtain an emulsified liquid. To a mixed thickening agent of 0.110 parts by mass of Keltrol CG-LAX-T, 0.200 parts by mass of Proxel GXL, 5.000 parts by mass of Propylene glycol, and 5.690 parts by mass of water, the emulsified liquid, 43.964 parts by mass of water, and 24.321 parts by mass of an aqueous Dicamba DGA solution (acid equivalent concentration: 40 mass %) were added, and stirred to obtain a pesticidal composition. The pesticidal compositions obtained in Production Examples 2, 8, 9, and 15 are designated as pesticidal compositions 2, 8, 9, and 15, respectively.

### Production Examples 12, 19, and 21

To an aqueous solution containing 2.500 parts by mass of the surfactant specified in Table 2 dissolved in 8.679 parts by mass of an aqueous Dicamba DGA solution (acid equivalent concentration: 40 mass %), a solution containing 0.536 parts by mass of the compound (I) active substance (purity: 98 mass %) dissolved in 5.250 parts by mass of Solvesso 200ND was added, and emulsified using Polytron homogenizer (manufactured by KINEMATICA) to obtain an emulsified liquid. To a mixed thickening agent of 0.110 parts by mass of Keltrol CG-LAX-T, 0.200 parts by mass of Proxel GXL, 5.000 parts by mass of Propylene glycol, and 5.690 parts by mass of water, the emulsified liquid, 43.964 parts by mass of water, and 28.071 parts by mass of an aqueous Dicamba DGA solution (acid equivalent concentration: 40 mass %) were added, and stirred to obtain a pesticidal composition. The pesticidal compositions obtained in Production Examples 12, 19, and 21 are designated as pesticidal compositions 12, 19, and 21, respectively.

### Production Examples 4, 10, and 16

0.536 parts by mass of the compound (I) active substance (purity: 98 mass %) and 2.500 parts by mass of the surfactant specified in Table 1 or 2 were dissolved in 5.250 parts by mass of Solvesso 200ND, and emulsified in 12.429 parts by mass of an aqueous Dicamba DGA solution (acid equivalent concentration: 40 mass %) using Polytron homogenizer (manufactured by KINEMATICA) to obtain an emulsified liquid. To a mixed thickening agent of 0.110 parts by mass of Keltrol CG-LAX-T, 0.200 parts by mass of Proxel GXL, 5.000 parts by mass of Propylene glycol, and 5.690 parts by mass of water, the emulsified liquid, 43.964 parts by mass of water, and 24.321 parts by mass of an aqueous Dicamba DGA solution (acid equivalent concentration: 40 mass %) were added, and stirred to obtain a pesticidal composition. The pesticidal compositions obtained in Production Examples 4, 10, and 16 are designated as pesticidal compositions 4, 10, and 16, respectively.

### Test Example 1: Storage Stability of Pesticidal Composition

The pesticidal composition was placed in a glass vessel and stored at 54° C. Ten days after the storage started, the pesticidal composition was visually examined to confirm the presence or absence of oil separation. As a result, pesticidal compositions 4, 10, 12, 16, 19 and 21 had oil separation, and pesticidal compositions 2, 3, 8, 9, 14, 15, 17 and 18 had no oil separation. The oil separation refers to a state in which unified oil droplets are separated from an aqueous phase or the phase of an emulsion. A pesticidal composition having no oil separation can be evaluated as having favorable storage stability. Likewise, as a result of evaluating pesticidal compositions 1, 5, 6, 7, 11, 13 and 20 for their storage stability, all of them have no oil separation and are thus confirmed to have favorable storage stability.

TABLE 1

| | | The | | | | | | | | | | |
|---|---|---|---|---|---|---|---|---|---|---|---|---|
| | | number | | | | | | | | | | |
| | | of | | | | | | | | | | |
| | | added | Pesticidal composition | | | | | | | | | |
| | | EO | 1 | 2 | 3 | 4 | 5 | 6 | 7 | 8 | 9 | 10 |
| Pesticidal active | Compound (I) (purity: | | 0.536 | 0.536 | 0.536 | 0.536 | 0.536 | 0.536 | 0.536 | 0.536 | 0.536 | 0.536 |
| compound | 98%) | | | | | | | | | | | |
| | Dicamba DGA | | 21.683 | 21.683 | 21.683 | 21.683 | 21.683 | 21.683 | 21.683 | 21.683 | 21.683 | 21.683 |
| Organic solvent | Solvesso 200ND | | 5.250 | 5.250 | 5.250 | 5.250 | 5.250 | 5.250 | 5.250 | 5.250 | 5.250 | 5.250 |
| Surfactant | Genapol T-500P | 50 | 2.500 | | | | | | | | | |
| | Brij CS17 | 17 | | 2.500 | | | | | | | | |
| | Brij O20 | 20 | | | 2.500 | | | | | | | |
| | MAKON TD-6 | 6 | | | | 2.500 | | | | | | |
| | Emulsogen EL540 | 54 | | | | | 2.500 | | | | | |
| | Toximul 8242 | 40 | | | | | | 2.500 | | | | |
| | Toximul 8241 | 30 | | | | | | | 2.500 | | | |
| | Toximul 8243 | 20 | | | | | | | | 2.500 | | |
| | Toximul 8244 | 16 | | | | | | | | | 2.500 | |
| | Etocas 10 | 10 | | | | | | | | | | 2.500 |
| Thickener | Keltrol CG-LAX-T | | 0.110 | 0.110 | 0.110 | 0.110 | 0.110 | 0.110 | 0.110 | 0.110 | 0.110 | 0.110 |
| Antiseptic | Proxel GXL | | 0.200 | 0.200 | 0.200 | 0.200 | 0.200 | 0.200 | 0.200 | 0.200 | 0.200 | 0.200 |
| Antifreezing | Propylene glycol | | 5.000 | 5.000 | 5.000 | 5.000 | 5.000 | 5.000 | 5.000 | 5.000 | 5.000 | 5.000 |
| agent | | | | | | | | | | | | |

| | | | | | | | | | | |
|---|---|---|---|---|---|---|---|---|---|---|
| Water | 64.721 | 64.721 | 64.721 | 64.721 | 64.721 | 64.721 | 64.721 | 64.721 | 64.721 | 64.721 |
| Total | 100.0 | 100.0 | 100.0 | 100.0 | 100.0 | 100.0 | 100.0 | 100.0 | 100.0 | 100.0 |

TABLE 2

| | | The | | | | | | | | | | | |
|---|---|---|---|---|---|---|---|---|---|---|---|---|---|
| | | number | | | | | | | | | | | |
| | | of | | | | | | | | | | | |
| | | added | Pesticidal composition | | | | | | | | | | |
| | | EO | 11 | 12 | 13 | 14 | 15 | 16 | 17 | 18 | 19 | 20 | 21 |
| Pesticidal | Compound (I) | | 0.536 | 0.536 | 0.536 | 0.536 | 0.536 | 0.536 | 0.536 | 0.53€ | 0.536 | 0.536 | 0.536 |
| active | (purity: 98%) | | | | | | | | | | | | |
| compound | Dicamba DGA | | 21.683 | 21.683 | \|21.683 | 21.683 | 21.683 | 21.683 | 21.683 | 21.683 | 21.683 | 21.683 | 21.683 |
| Organic | Solvesso 200ND | | 5.250 | 5.250 | 5.250 | 5.250 | 5.250 | 5.250 | 5.250 | 5.250 | 5.250 | 5.250 | 5.250 |
| solvent | | | | | | | | | | | | | |
| Surfactant | Emulsogen TS540 | 54 | 2.500 | | | | | | | | | | |
| | Emulsogen TS200 | 20 | | 2.500 | | | | | | | | | |
| | Myrj S100 | 100 | | | 2.500 | | | | | | | | |
| | Myrj S40 | 40 | | | | 2.500 | | | | | | | |
| | Myrj S20 | 20 | | | | | 2.500 | | | | | | |
| | Myrj S8 | 8 | | | | | | 2.500 | | | | | |
| | Tween 60 | 20 | | | | | | | 2.500 | | | | |
| | Tween 80 | 20 | | | | | | | | 2.500 | | | |
| | Tween 21 | 4 | | | | | | | | | 2.500 | | |
| | Stepflow 26F | 54 | | | | | | | | | | 2.500 | |
| | Genapol PF20 | 11 | | | | | | | | | | | 2.500 |
| Thickener | Keltrol CG-LAX-T | | 0.110 | 0.110 | 0.110 | 0.110 | 0.110 | 0.110 | 0.110 | 0.110 | 0.110 | 0.110 | 0.110 |
| Antiseptic | Proxel GXL | | 0.200 | 0.200 | 0.200 | 0.200 | 0.200 | 0.200 | 0.200 | 0.200 | 0.200 | 0.200 | 0.200 |
| Antifreezing | Propylene glycol | | 5.000 | 5.000 | 5.000 | 5.000 | 5.000 | 5.000 | 5.000 | 5.000 | 5.000 | 5.000 | 5.000 |
| agent | | | | | | | | | | | | | |

| | | | | | | | | | | | |
|---|---|---|---|---|---|---|---|---|---|---|---|
| Water | 64.721 | 64.721 | 64.721 | \|64.721 | 64.721 | 64.721 | 64.721 | 64.721 | 64.721 | 64.721 | 64.721 |
| Total | 100.0 | 100.0 | 100.0 | 100.0 | 100.0 | 100.0 | 100.0 | 100.0 | 100.0 | 100.0 | 100.0 |

### Test Example 2

The weeds (Palmer amaranth (Amarantbus palmeri), narrow leaf Amaranthus (Amarantbus graecizanus), common ragweed (Ambrosia artemisiaefolia), giant ragweed (Ambrosia trrjida), marestail (Conyza canadensis), common lambsquarters (Chenopodium album), kochia (Kochia scoparia), common barnyardgrass (Echinochloa cruts-galli) and giant foxtail (Setaria faberi)) are seeded to a plastic pot containing soil. On the same day, the surface of soil is treated with a mixture of any one of pesticidal compositions 1 to 21 (except for 4, 10, 12, 16, 19, and 21), Agri-Dex (mixture of heavy paraffin oil, polyhydric alcohol fatty acid ester, and a polyethoxylate derivative, manufactured by Helena Chemical, specific gravity: 0.88), Intact (mixture of polyethylene glycol, choline chloride, and guar gum, manufactured by Precision Laboratories, specific gravity: 1.06), Vapex, a VaporGrip Xtra Agent (mixture of potassium hydroxide and acetic acid, manufactured by Kalo, specific gravity: 1.27) and water. Their respective amounts in the treatment are 3810 g/ha of the pesticidal composition, 1232 g/ha of Agri-Dex, 742 g/ha of Intact, and 1858 g/ha of Vapex, a VaporGrip Xtra Agent, and the amount of the spray liquid is 140 L/ha. Then, they are cultivated in a greenhouse. Seven days later, soybean is seeded. Fourteen days later, a weed control effect and a crop injury to the soybean are investigated. When any of the formulations is used, an excellent weed control effect is confirmed.

### Test Example 3

The weeds (Palmer amaranth (Amaranthus palmeri), narrow leaf Amaranthus (Amaranthus graecizanus), common ragweed (Ambrosia artemisiaefolia), giant ragweed (Ambrosia trifida), marestail (Conyza canadensis), common lambsquarters (Chenopodium album), kochia (Kochia scoparia), common barnyardgrass (Echinochloa crus-galli) and giant foxtail (Setaria faberi)) are seeded to a plastic pot containing soil. On the same day, the surface of soil is treated with a mixture of any one of pesticidal compositions 1 to 21 (except for 4, 10, 12, 16, 19, and 21), Agri-Dex (mixture of heavy paraffin oil, polyhydric alcohol fatty acid ester, and a polyethoxylate derivative, manufactured by Helena Chemical, specific gravity: 0.88), Intact (mixture of polyethylene glycol, choline chloride, and guar gum, manufactured by Precision Laboratories, specific gravity: 1.06), Vapex, a VaporGrip Xtra Agent (mixture of potassium hydroxide and acetic acid, manufactured by Kalo, specific gravity: 1.27) and water. Their respective amounts in the treatment are 3810 g/ha of the pesticidal composition, 1232 g/ha of Agri-Dex, 742 g/ha of Intact, and 389 g/ha of Vapex, a VaporGrip Xtra Agent, and the amount of the spray liquid is 140 L/ha. Then, they are cultivated in a greenhouse. Seven days later, soybean is seeded. Fourteen days later, a weed control effect and a crop injury to the soybean are investigated. When any of the formulations is used, an excellent weed control effect is confirmed.

1. A pesticidal composition comprising a compound represented by the formula (I), a herbicidal active salt, an organic solvent having a water solubility at 25° C. of 10 mass % or less, a surfactant and water, wherein
the surfactant comprises one or more nonionic surfactants selected from a group (A): 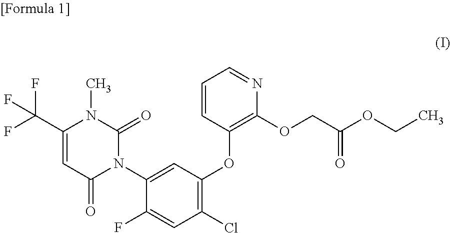 [SMILES: CCOC(=O)COc1ncccc1Oc1cc(-n2c(=O)cc(C(F)(F)F)n(C)c2=O)c(F)cc1Cl]
group (A): the group consisting of polyoxyethylene alkyl ethers having the number of added EO exceeding 6, polyoxyethylene aryl ethers having the number of added EO exceeding 20, polyoxyethylene sorbitan fatty acid esters having the number of added EO exceeding 4, polyoxyethylene polyoxypropylene block copolymers having the number of added EO exceeding 11, polyoxyethylene castor oils having the number of added EO exceeding 10, and polyoxyethylene fatty acid esters having the number of added EO exceeding 8.

2. The pesticidal composition according to claim 1, wherein the herbicidal active salt comprises a herbicidal active carboxylate.

3. The pesticidal composition according to claim 1, wherein the herbicidal active salt comprises one or more herbicidal active salts selected from the group consisting of a herbicidal active benzoate and a herbicidal active phenoxyacetate.

4. The pesticidal composition according to claim 1, wherein the herbicidal active salt comprises one or more herbicidal active salts selected from the group consisting of a dicamba salt and a 2,4-D salt.

5. The pesticidal composition according to claim 1, wherein the herbicidal active salt comprises a dicamba salt.

6. The pesticidal composition according to claim 1, wherein the herbicidal active salt comprises dicamba diglycolamine.

7. The pesticidal composition according to claim 1, wherein the surfactant is one or more nonionic surfactants selected from the group (A).

8. The pesticidal composition according to claim 1, wherein the pesticidal composition contains an aqueous phase and particles of an oil phase dispersed in the aqueous phase, wherein
the oil phase contains the organic solvent and the compound represented by the formula (I) dissolved or suspended in the organic solvent.

9. The pesticidal composition according to claim 1, wherein the organic solvent comprises an aromatic hydrocarbon.
